(19) United States
(12) Patent Application Publication
(10) Pub. No.: US 2018/0330218 A1
(43) Pub. Date: Nov. 15, 2018

(54) POLYISOCYANURATE FOAM BOARD INCORPORATING RFID TAGS

(71) Applicant: Building Materials Investment Corporation, Dallas, TX (US)

(72) Inventors: Robert John Marciello, Stewartsville, NJ (US); Igor Alovert, Morristown, NJ (US); Christopher Solarczyk, Kinnelon, NJ (US); Anthony Joseph Cipiti, JR., Lewisville, TX (US)

(21) Appl. No.: 15/592,778

(22) Filed: May 11, 2017

(51) Int. Cl. G06K 19/077

(52) U.S. Cl. CPC G06K 19/0772

(57) ABSTRACT

Polyisocyanurate boards are disclosed that comprise an RFID tag that is capable of storing identifying information. The RFID tags may be embedded in the polyisocyanurate foam. By appropriate positioning of the embedded RFID tags in the boards, non-specialized RFID tags can be used without the tags being damaged by the heat and dynamic forces encountered during manufacturing. A method of manufacturing the boards is also disclosed.

### FIELD OF THE INVENTION

This invention relates to polyisocyanurate insulation boards that incorporate RFID tags, in particular to boards in which RFID tags are embedded in the polyisocyanurate foam, and to related methods of manufacture. By positioning the RFID tags at specific locations in the polyisocyanurate foam, it has been found that embedded, non-specialized tags remain functional despite the elevated temperatures and dynamic forces encountered during manufacturing and curing of the boards. By embedding the RFID tags in the polyisocyanurate foam, the tags are protected from intentional or inadvertent removal from the finished boards and from environmental damage. The RFID tags can store identifying information that remains associated with the boards and that can be read even after installation of the boards in structures, facilitating inspection.

### BACKGROUND OF THE INVENTION

Polyisocyanurate foams are important building insulation materials, particularly in the form of “polyiso” board stock for wall and roof applications. Such materials are widely used because of their combination of thermal resistance, robustness, water resistance, light weight, durability and reduced air infiltration.

It would be useful to have a way to provide a board with identifying information (i.e., an identifier, such as a unique numeric or alphanumeric code) that remains readable throughout its lifetime. Other information about the board (such as its characteristics, customer information, installer, repair records etc.) could then be associated with the identifier (e.g., in a database) and accessed and updated over time, thus facilitating inspection.

Although identifying information might be printed on the outside of a board, it would then be at risk of unwanted alteration or removal. In order to aid inspection, it would also be beneficial to be able to read identifying information from boards that have been incorporated into a structure and are thus invisible.

RFID (Radio Frequency Identification) tags are small, commercially available devices that are capable of electronically storing information and communicating by radio waves. Information, such as a unique identifier, can be programmed into a tag and then later read by radio wave interrogation with a suitable RFID reader. RFID tags may be attached to objects and have found various applications, particularly as means of identification. For example, U.S. Pat. Nos. 7,607,583, 8,181,580, 8,585,850, 9,404,581, 9,447,547 and 9,476,164 and PCT Pub. No. WO 2014/023980 disclose various applications of RFID tags (such as in credit cards and industrial mats) and related methods of manufacture. Because of their use of radio wave communication, RFID tags, unlike written text or barcodes, can be read when not in line of sight.

Although it might in principle be possible to affix RFID tags to the outside of polyisocyanurate boards, the tags could then be subject to unwanted removal and would be exposed to potential damage, such as from environmental moisture or physical impact. It would thus be desirable to embed RFID tags in the polyisocyanurate foam. In this way the tags would be protected from removal or environmental damage, but would still be readable (by radio wave communication).

In general, polyisocyanurate boards are constructed in a continuous process by applying liquid polyisocyanurate as a stream of foam to a sheet of material known as the bottom facer as it is rolled past application nozzles. Another sheet of facer (the top facer) is then immediately applied to the foam, creating a sandwich of facer-foam-facer. This sandwich is run through intense heat, causing the foam to cure (harden). The resulting boards are then cut and stacked and allowed to continue curing for 20-40 hours (depending on board thickness). The curing of polyisocyanurate is an exothermic reaction and the boards typically reach a temperature of up to about 300° F. The boards are subsequently packaged into bundles.

The terms “bottom facer” and “top facer” as used herein refer to the relative orientation of the facers during manufacturing. As explained above, the polyisocyanurate foam is applied to the bottom facer and the top facer is then positioned on the foam. It will be understood, however, that a finished polyisocyanurate foam board might be installed in a structure with either the top or bottom facer uppermost.

To embed an RFID tag in polyisocyanurate foam requires the tag to be introduced into the foam at a point in the manufacturing process before the foam hardens (i.e., before curing). This is challenging because of the prolonged high temperatures and dynamic forces (e.g., due to cutting and perforation) that are necessarily encountered during the manufacturing and curing of polyisocyanurate boards, as described above. Such conditions can compromise the readability of non-specialized RFID tags.

U.S. Pat. No. 8,284,028 and German Patent No. DE 20200801065 disclose methods of incorporating RFID tags into bituminous roofing products. Although the RFID tags are applied to hot bitumen in these methods, meaning that the tags must endure elevated temperatures, bitumen, unlike polyisocyanurate, cools rapidly. This U.S. patent is incorporated herein by reference in its entirety for all purposes within this application.

### SUMMARY OF THE INVENTION

One embodiment of this invention pertains to a polyisocyanurate foam board that incorporates one (or more) RFID tags. The RFID tag allows a board to be given a unique identifier with which other information about the board (such as identity of the manufacturer and characteristics of the board) can be associated and stored (e.g., in a database). The RFID tag permits the identity of the board to be read even after the board is installed in a structure.

In a preferred embodiment the RFID tag is embedded in the polyisocyanurate foam. By embedding the RFID tag in the foam it is less likely to be intentionally or inadvertently removed or to suffer environmental damage.

In a preferred embodiment the RFID tag is embedded in the polyisocyanurate foam close to an edge of the board. Preferably, the RFID tag is embedded in the polyisocyanurate foam close to a side edge or corner of the board. These positions are preferred since they cool fastest after manufacturing and curing and thus improve the thermal survival of the tag.

In a preferred embodiment the RFID tag is affixed to a facer of the polyisocyanurate board. Preferably, the RFID tag is affixed to the inner surface of the bottom facer. In one embodiment the RFID tag is attached parallel to the facer. In another embodiment the tag is attached perpendicular to the facer. If attached perpendicular to the facer, the RFID tag may be folded or creased. In another embodiment the RFID tag is dropped into the liquid polyisocyanurate foam.

In a preferred embodiment the surface of the RFID tag comprises polyester.

In a preferred embodiment, Applicant's polyisocyanurate foam board comprises:

(a) a top facer;

(b) a bottom facer;

(c) a front edge;

(d) a back edge;

(e) two side edges; and

(f) one or more RFID tags.

In a preferred embodiment, the board comprises one RFID tag.

In a preferred embodiment, the RFID tag is embedded in the polyisocyanurate foam.

In one embodiment, the RFID tag is located within about 12 inches from an edge of the board. In another embodiment, the RFID tag is located within about 8 inches from an edge of the board. In a preferred embodiment, the RFID tag is located within about 12 inches from a side edge of the board. In a preferred embodiment, the RFID tag is located within about 8 inches from a side edge of the board. In another preferred embodiment, the RFID tag is further located within about 8 inches from the front edge or the back edge of the board.

In a preferred embodiment, the RFID tag is attached to a facer. In a preferred embodiment, the RFID tag is attached to the bottom facer. In a further preferred embodiment, the RFID tag is attached to the bottom facer with adhesive.

In one embodiment, the RFID tag is attached parallel to the bottom facer. In a preferred embodiment, the RFID tag is attached perpendicular to the bottom facer. In a preferred embodiment, the RFID tag has a long edge and is attached to the facer by said long edge. In a further preferred embodiment, the RFID tag is oriented such that said long edge is parallel to the side edges of the board.

In one embodiment, the RFID tag is bent.

In another embodiment, the RFID tag is not attached to a facer.

In a preferred embodiment, the RFID tag comprises polyester.

In a preferred embodiment, the RFID tag stores identifying information.

In a preferred embodiment, a bundle of polyisocyanurate boards comprises at least one polyisocyanurate foam board comprising:

(a) a top facer;

(b) a bottom facer;

(c) a front edge;

(d) a back edge;

(e) two side edges; and

(f) one or more RFID tags.

In a preferred embodiment, the bundle comprises between 8 and 50 polyisocyanurate boards.

In a preferred embodiment, the bundle comprises at least one polyisocyanurate board that does not comprise an RFID tag. In a preferred embodiment, the bundle comprises one polyisocyanurate board that comprises one or more RFID tags.

In a preferred embodiment, a method of making an inventive polyisocyanurate foam board is provided, the polyisocyanurate foam board comprising:

(a) a top facer;

(b) a bottom facer;

(c) a front edge;

(d) a back edge;

(e) two side edges; and

(f) one or more RFID tags

In a preferred embodiment, the method comprises the steps of:

(i) applying liquid polyisocyanurate to the bottom facer;

(ii) applying a top facer to the polyisocyanurate;

(iii) heat curing the board; and

(iv) cutting the board.

In a preferred embodiment, the board comprises one RFID tag.

In a preferred embodiment, the RFID tag is embedded in the polyisocyanurate foam.

In a preferred embodiment, the method further comprises the step of attaching the RFID tag to a facer. In a preferred embodiment, the RFID tag is attached to the bottom facer before applying the liquid polyisocyanurate.

In one embodiment, the RFID tag is attached parallel to the bottom facer. In a preferred embodiment, the RFID tag is attached perpendicular to the bottom facer.

In one embodiment, the RFID tag is not attached to the bottom facer. In another embodiment the RFID tag is dropped into liquid polyisocyanurate before applying the top facer. In a further embodiment, the RFID tag is dropped into the liquid polyisocyanurate where two streams of polyisocyanurate foam meet as they expand.

In a preferred embodiment, the method further comprises the step of packaging the polyisocyanurate board into a bundle. In a preferred embodiment, the bundle comprises between 8 and 50 polyisocyanurate boards. In a further preferred embodiment, the bundle comprises at least one polyisocyanurate board that does not comprise an RFID tag.

In a preferred embodiment, the method further comprises one or more steps of programming and/or reading of the RFID tag. In a preferred embodiment, programming and/or reading the RFID tag occurs after applying the liquid polyisocyanurate to the bottom facer and before cutting the board. In a preferred embodiment, programming and/or reading the RFID tag further occurs during packaging of the polyisocyanurate board into a bundle.

### BRIEF DESCRIPTION OF THE FIGURES

For a more complete understanding of the present invention and the advantages thereof, reference is made to the following descriptions, taken in conjunction with the accompanying figures, in which:

FIG. 1 is a perspective view of a polyisocyanurate foam board with a side edge and corner zone labelled.

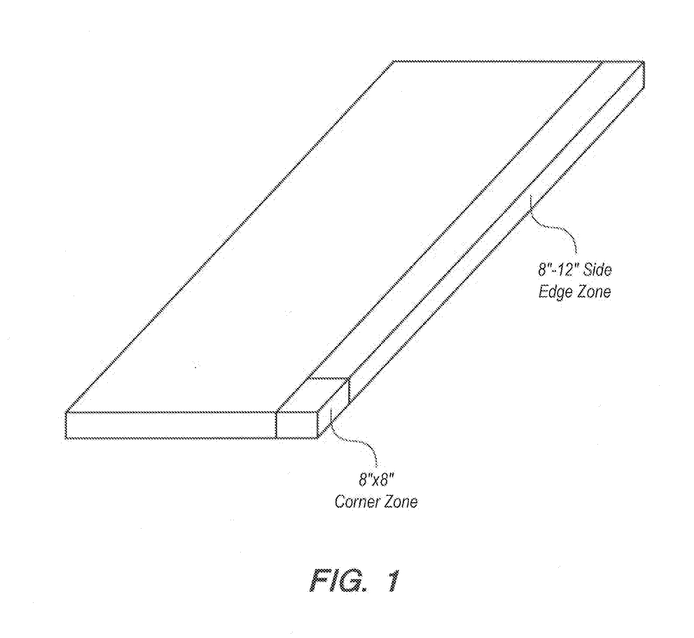

FIG. 2 is a cross-sectional view of a polyisocyanurate foam board having an RFID tag attached in a parallel orientation to the inner surface of the bottom facer.

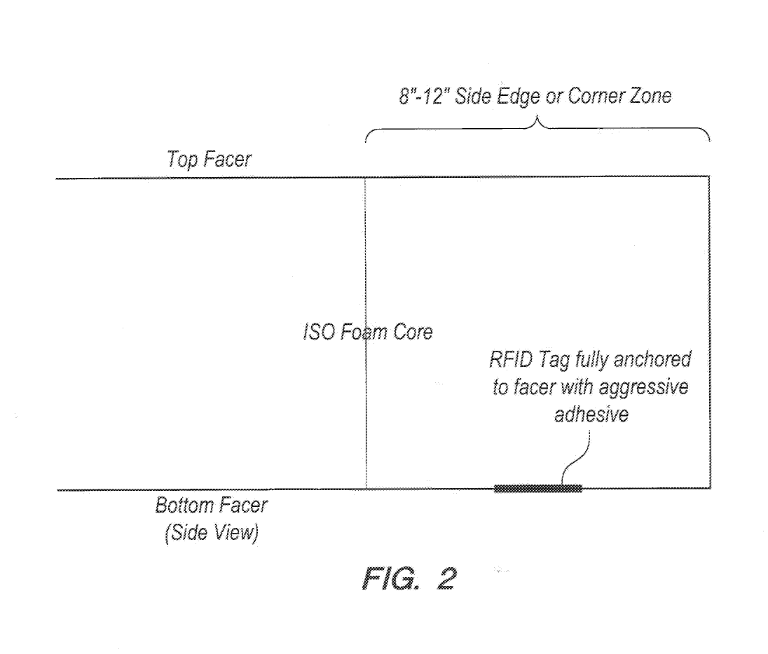

FIG. 3 is a cross-sectional view of a polyisocyanurate foam board having an RFID tag attached in a perpendicular orientation to the inner surface of the bottom facer.

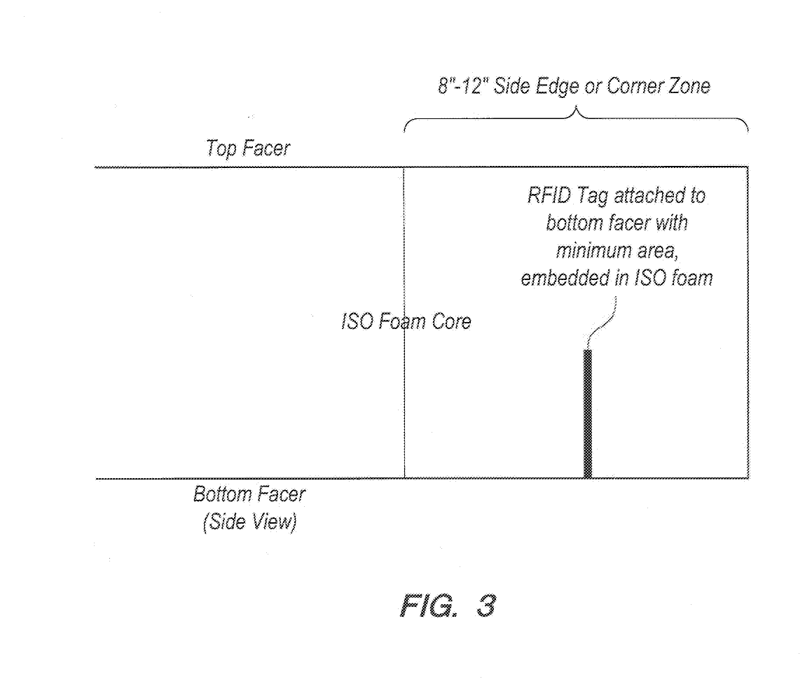

FIG. 4 is a perspective view illustrating the application of liquid polyisocyanurate foam to the bottom facer during continuous production of polyisocyanurate foam board.

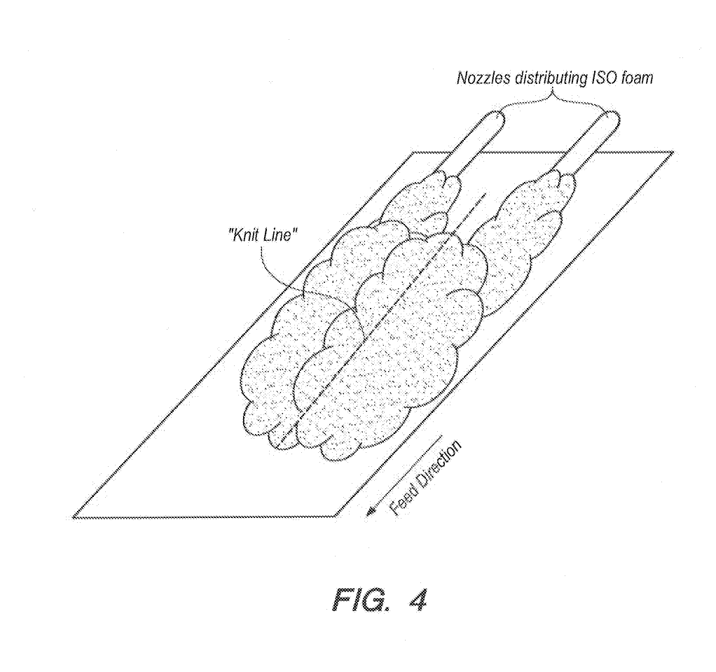

FIG. 5 is a cross-sectional view of a polyisocyanurate foam board having an RFID tag embedded in the foam but not attached to a facer in an edge or corner zone.

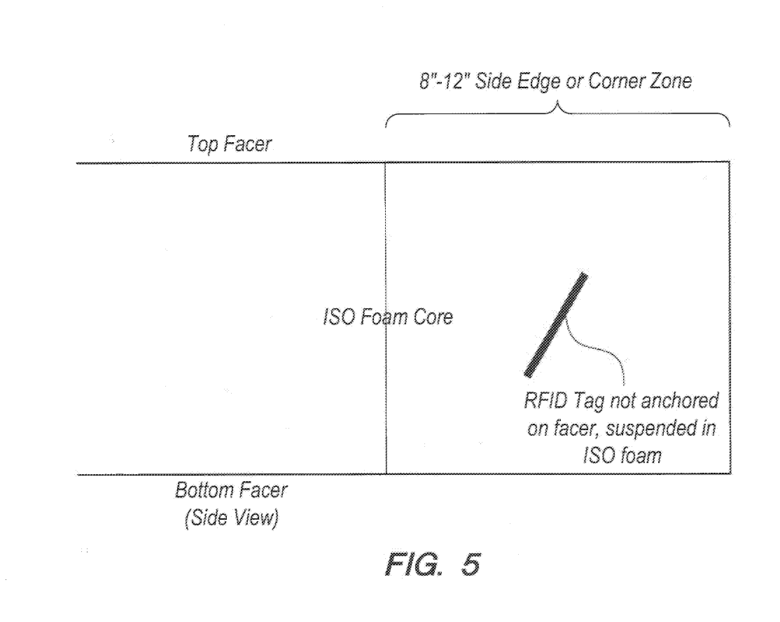

### DETAILED DESCRIPTION

One embodiment of this invention pertains to a polyisocyanurate foam board that incorporates one or more RFID tags. In a preferred embodiment the board comprises one RFID tag. Preferably, the RFID tag is embedded in the polyisocyanurate foam. Suitable RFID tags are available, for example, from RMS Omega Technologies, Avery Dennison, Starport Technologies, Repack Inc., RR Donnelly and ID Technology.

Typically, polyisocyanurate boards are produced in a rectangular shape with shorter front and back edges and longer side edges. Preferably, an RFID tag is embedded in the polyisocyanurate foam within about 12 inches or within about 8 inches of an edge of a board. In a preferred embodiment, the RFID tag is embedded in the polyisocyanurate foam within about 12 inches or within about 8 inches of a side edge of a board. In another embodiment, the RFID tag is embedded in the polyisocyanurate foam within about 12 inches or within about 8 inches of a front or back edge of a board. In a particularly preferred embodiment, the RFID tag is embedded in the polyisocyanurate foam within about 8 inches of a side edge of the board and within about 8 inches of a front or back edge of the board (i.e., in the corner of the board). It is thought that the survival of the RFID tag is improved in these locations as they are the fastest to cool after curing, thus reducing the likelihood of heat damage to the tag during manufacturing.

Preferably, the RFID tag is attached to a facer of the board. In a preferred embodiment, the RFID tag is attached to an inner surface (i.e., the surface that contacts the polyisocyanurate foam) of a facer. In a particularly preferred embodiment, the RFID tag is attached to the inner surface of the bottom facer. The RFID tag is attached to the bottom facer before application of the liquid polyisocyanurate foam and the tag becomes embedded in the polyisocyanurate foam as the foam hardens.

In a preferred embodiment, the RFID tag is attached to the inner surface of the bottom facer in a parallel orientation to the facer i.e., the face of the tag with the largest surface area is affixed to the bottom facer. In another preferred embodiment the RFID tag is attached to the inner surface of the bottom facer in a perpendicular orientation i.e., an edge of the tag is affixed to the facer. Preferably the long edge of the tag is attached to the facer. The RFID tag may be creased or bent so that it remains perpendicular to the bottom facer when the liquid polyisocyanurate foam is poured. Preferably the RFID tag is oriented such that its long edge is parallel to the side edges of the board.

The RFID tag can be attached to the facer with adhesive. An example of a suitable adhesive is Fasson S490 that is available from Avery Dennison. Commercial RFID tags having a pre-applied adhesive are also suitable. The adhesive prevents the tag from becoming damaged by distorting or warping due to heat or dynamic forces.

In another embodiment the RFID tag is attached to the inner surface of the top facer of the board. This might be achieved, for example, by blowing a self-adhesive RFID tag onto the inner surface of the top facer before it is applied to the polyisocyanurate foam.

In another embodiment the RFID tag is not attached to a facer but is dropped into the polyisocyanurate foam immediately after the applicator dispenses the foam onto the bottom facer before it hardens. For example, the tag may be dropped into the liquid polyisocyanurate foam in an area where two streams of polyisocyanurate foam meet as they expand. This is referred to as the knit line.

Preferably, the RFID tag has a polyester surface. It is has been found that this improves adhesion to the polyisocyanurate foam and allows the RFID tag to act as reinforcement for the foam. In another embodiment, the RFID tag is covered with a layer of material that mimics the texture of the board. This means that the polyisocyanurate foam adheres to the RFID tag as strongly as it adheres to the facer, with the result that a physical weak point in the board is not created by the presence of the tag.

The RFID tag may be programmed with identifying information during manufacturing or may be preprogrammed with identifying information that is read from it by an appropriate device during manufacturing. Programming and/or reading of the identifying information from the tag may occur at one or more steps during the manufacturing process. In a preferred embodiment, programming and/or reading of the tag occurs (i) between lamination of the polyisocyanuate foam with the top facer and the cutting of the boards; and/or (ii) during packing of bundles of boards (i.e., at the hooding stage).

An embedded RFID tag permits information about the properties of a polyisocyanurate board to be readily ascertained and updated throughout the board's lifetime. During manufacturing the identifying information stored on the RFID tag is entered, for example, in a database along with information about the board in which it is embedded. This can include, for example, date and location of manufacture and thickness of the board. Later, further information about the board can be added to the database, such as its date of installation. Subsequently, an inspector of a structure comprising the installed board can read the identifying information from the embedded RFID tag and access the database to ascertain the board's manufacturing and installation records.

Multiple polyisocyanurate boards are needed to insulate a typical structure. This means that even if only a fraction of the installed boards contain an RFID tag, there will still be a number of tagged boards in the structure. If the tagged boards are representative of the untagged boards (e.g., they are manufactured at the same time and have the same characteristics), it is therefore not necessary that every board contains an RFID tag. For example, there may be one tag in every bundle of boards, for example, one tag in every 8 to 50 boards. Alternatively, there may be a tag in every other board, a tag in every board, or even multiple tags per board.

What is claimed is:

1. A polyisocyanurate foam board comprising,
(a) a top facer;
(b) a bottom facer;
(c) a front edge;
(d) a back edge;
(e) two side edges; and
(f) one or more RFID tags.

2. The board of claim 1, wherein the board comprises one RFID tag.

3. The board of claim 2, wherein the RFID tag is embedded in the polyisocyanurate foam.

4. The board of claim 3, wherein the RFID tag is located within about 12 inches from an edge of the board.

5. The board of claim 3, wherein the RFID tag is located within about 8 inches from an edge of the board.

6. The board of claim 4, wherein the RFID tag is located within about 12 inches from a side edge of the board.

7. The board of claim 5, wherein the RFID tag is located within about 8 inches from a side edge of the board.

8. The board of claim 7, wherein the RFID tag is further located within about 8 inches from the front edge or the back edge of the board.

9. The board of claim 3, wherein the RFID tag is attached to a facer.

10. The board of claim 9, wherein the RFID tag is attached to the bottom facer.

11. The board of claim 10, wherein the RFID tag is attached to the bottom facer with adhesive.

12. The board of claim 10, wherein the RFID tag is attached parallel to the bottom facer.

13. The board of claim 10, wherein the RFID tag is attached perpendicular to the bottom facer.

14. The board of claim 13, wherein the RFID tag has a long edge and is attached to the facer by said long edge.

15. The board of claim 14, wherein the RFID tag is oriented such that said long edge is parallel to the side edges of the board.

16. The board of claim 13, wherein the RFID tag is bent.

17. The board of claim 3, wherein the RFID tag is not attached to a facer.

18. The board of claim 3, wherein the RFID tag comprises polyester.

19. The board of claim 3, wherein the RFID tag stores identifying information.

20. A bundle of polyisocyanurate boards comprising at least one polyisocyanurate board according to claim 1.

21. The bundle of claim 20, wherein the bundle comprises between 8 and 50 polyisocyanurate boards.

22. The bundle of claim 21, wherein the bundle comprises at least one polyisocyanurate board that does not comprise an RFID tag.

23. The bundle of claim 22, wherein the bundle comprises one polyisocyanurate board according to claim 1.

24. A method of making a polyisocyanurate foam board comprising,
(a) a top facer;
(b) a bottom facer;
(c) a front edge;
(d) a back edge;
(e) two side edges; and
(f) one or more RFID tags.

25. The method of claim 24, wherein the method comprises the steps of:
(i) applying liquid polyisocyanurate to the bottom facer;
(ii) applying a top facer to the polyisocyanurate;
(iii) heat curing the board; and
(iv) cutting the board.

26. The method of claim 25, wherein the board comprises one RFID tag.

27. The method of claim 26, wherein the RFID tag is embedded in the polyisocyanurate foam.

28. The method of claim 27, further comprising the step of attaching the RFID tag to a facer.

29. The method of claim 28, wherein the RFID tag is attached to the bottom facer before applying the liquid polyisocyanurate.

30. The method of claim 29, wherein the RFID tag is attached parallel to the bottom facer.

31. The method of claim 29, wherein the RFID tag is attached perpendicular to the bottom facer.

32. The method of claim 27, wherein the RFID tag is not attached to the bottom facer.

33. The method of claim 32, wherein the RFID tag is dropped into liquid polyisocyanurate before applying the top facer.

34. The method of claim 33, wherein the RFID tag is dropped into the liquid polyisocyanurate where two streams of polyisocyanurate foam meet as they expand.

35. The method of claim 27, further comprising the step of packaging the polyisocyanurate board into a bundle.

36. The method of claim 35, wherein the bundle comprises between 8 and 50 polyisocyanurate boards.

37. The method of claim 36, wherein the bundle comprises at least one polyisocyanurate board that does not comprise an RFID tag.

38. The method of claim 35, further comprising one or more steps of programming and/or reading of the RFID tag.

39. The method of claim 38, wherein programming and/or reading the RFID tag occurs after applying the liquid polyisocyanurate to the bottom facer and before cutting the board.

40. The method of claim 39, wherein programming and/or reading the RFID tag further occurs during packaging of the polyisocyanurate board into a bundle.
